(19) United States
(12) Patent Application Publication
(10) Pub. No.: US 2003/0148691 A1
(43) Pub. Date: Aug. 7, 2003

(54) Adhesive materials and articles containing the same

(76) Inventors: Matthew C. Pelham SR., Buford, GA (US); Nigel J. Flynn, Duluth, GA (US)

Correspondence Address: MERCHANT & GOULD PC, P.O. BOX 2903, MINNEAPOLIS, MN, 55402-0903, US

(21) Appl. No.: 10/354,760

(22) Filed: Jan. 30, 2003

Related U.S. Application Data
(60) Provisional application No. 60/354,030, filed on Jan. 30, 2002.

(51) Int. Cl. D04H 3/14; D04H 3/00; B32B 5/26

(52) U.S. Cl. 442/347; 442/409; 442/414; 442/340; 442/350; 442/351; 442/381; 442/361; 156/308.2

(57) ABSTRACT

Adhesive materials and articles containing adhesive materials are disclosed. Adhesive articles include adhesive fibers, adhesive films, an adhesive layer of fibers, adhesive nonwoven webs, and articles containing one or more of the adhesive materials. Stretched adhesive materials are also disclosed. Methods of making and using the adhesive materials and articles are also disclosed.

### CROSS-REFERENCE TO RELATED APPLICATIONS

This patent application claims the benefit of priority to U.S. provisional patent application serial No. 60/354,030, filed on Jan. 30, 2002.

### FIELD OF THE INVENTION

The present invention relates to adhesive materials and methods of making such adhesive materials. The present invention further relates to articles of manufacture containing one or more adhesive materials and methods of using the articles.

### BACKGROUND OF THE INVENTION

Fibers having adhesive properties, adhesive nonwoven webs containing the fibers, and adhesive films are useful for bonding one or more substrates to one another.

What is needed in the art is adhesive materials, such as adhesive fibers, adhesive films, an adhesive layer of fibers, and adhesive nonwoven webs having one or more of the following properties:

(1) desired adhesive properties;

(2) desired processability;

(3) desired physical properties, such as a desired amount of tear strength and a desired melting point; and

(4) a desired cost of making.

### SUMMARY OF THE INVENTION

The present invention is directed to adhesive materials. The adhesive materials of the present invention include, but are not limited to, adhesive fibers, adhesive films, an adhesive layer of fibers, adhesive nonwoven webs, and articles containing one or more of the adhesive materials. The adhesive fibers, adhesive film, adhesive layer of fibers or adhesive nonwoven web may be used to bond one substrate to itself or to bond two or more separate substrates to one another. In an exemplary embodiment of the present invention, the adhesive material comprises an adhesive nonwoven web comprising a plurality of fibers bonded to one another, wherein the fibers comprise a copolymer of (a) ethylene and at least one of (b) acrylic acid, methacrylic acid, vinyl acetate, and octene. The adhesive nonwoven web may be permanently or temporarily bonded to at least one additional layer to form a multi-layer article.

In a further exemplary embodiment of the present invention, the adhesive material comprises an adhesive fiber, wherein the fiber comprises a copolymer of (a) ethylene and at least one of (b) acrylic acid, methacrylic acid, vinyl acetate, methyl acrylate, and octene. In yet a further exemplary embodiment of the present invention, the adhesive material comprises an adhesive layer of fibers, wherein at least a portion of the fibers comprise fibers formed from a copolymer of (a) ethylene and at least one of (b) acrylic acid, methacrylic acid, vinyl acetate, methyl acrylate, and octene. In another exemplary embodiment of the present invention, the adhesive material comprises an adhesive film, wherein at least a portion of the film comprises a copolymer of (a) ethylene and at least one of (b) acrylic acid, methacrylic acid, vinyl acetate, methyl acrylate, and octene. The adhesive fibers, adhesive layer of fibers, or adhesive film may each independently be permanently or temporarily bonded to at least one additional layer to form a multi-layer article.

The present invention is also directed to adhesive materials containing at least one stretched layer. The stretched adhesive materials may contain one or more of the above-described adhesive materials. The stretched adhesive materials may contain one or more stretched layers in combination with one or more unstretched layers.

The present invention is also directed to a method of making adhesive materials. In an exemplary embodiment of the present invention, the method comprises (i) melt extruding a copolymer through a plurality of spinnerets to form a plurality of fibers; and (ii) collecting the fibers on a collection surface to form a layer of fibers, wherein the copolymer comprises (a) ethylene and at least one of (b) acrylic acid, methacrylic acid, vinyl acetate, methyl acrylate, and octene. The layer of fibers may possess enough structural integrity to form an adhesive nonwoven web. The method may further comprise additional steps, such as a stretching step, wherein a web of fibers is stretched in one or more directions.

The present invention is even further directed to articles of manufacture comprising one or more similar or different substrates bonded to one another by one or more adhesive materials. The articles of manufacture may comprise (i) an adhesive layer or web comprising a plurality of fibers bonded to one another, wherein the fibers comprise a copolymer of (a) ethylene and at least one of (b) acrylic acid, methacrylic acid, vinyl acetate, methyl acrylate, and octene, and (ii) at least one substrate bonded to the adhesive layer or web.

These and other features and advantages of the present invention will become apparent after a review of the following detailed description of the disclosed embodiments and the appended claims.

### BRIEF DESCRIPTION OF THE DRAWINGS

The present invention is further described with reference to the appended figures, wherein:

FIG. 1 depicts an exemplary adhesive nonwoven web of the present invention;

FIG. 2 depicts an exemplary process for making an adhesive nonwoven web of the present invention;

FIG. 3 depicts an exemplary process for making a composite web of the present invention;

FIG. 4 depicts an exemplary process for making an adhesive nonwoven web of the present invention using an endless collection belt;

FIG. 5 depicts an exemplary die and collection surface used to make an adhesive nonwoven web of the present invention;

FIG. 6 is a cross-sectional view of a first substrate bonded to a second substrate via an adhesive nonwoven web of the present invention;

FIG. 7A depicts an exemplary stretching process for stretching a nonwoven composite material or one or more layers of the nonwoven composite material;

FIG. 7B depicts a cross-sectional view of the apparatus used in the stretching process of FIG. 7A; and

FIGS. 8A and 8B depict exemplary cross-sectional configurations for composite materials of the present invention.

### DETAILED DESCRIPTION OF THE INVENTION

The present invention is directed to adhesive materials such as adhesive fibers, adhesive films, an adhesive layer of fibers, adhesive nonwoven webs, and articles containing one or more of the adhesive materials. The adhesive materials (1) have exceptional adhesive properties; (2) have superior physical properties, such as a desired amount of tear strength and a desired melting point; and (3) can be manufactured in a cost-effective manner. The present invention is also directed to methods of making the adhesive materials and articles of manufacture comprising the adhesive materials.

I. Adhesive Nonwoven Webs

The adhesive nonwoven webs of the present invention may comprise a plurality of fibers bonded to one another, wherein the resulting web has desired adhesive properties. The fibers may be autogenously bonded to one another or may be bonded to one another using an external source of heat and/or pressure. As used herein, the term “autogenously bonded” is used to describe fibers, which bond to one another as the fibers come into contact with one another after leaving an extrusion die.

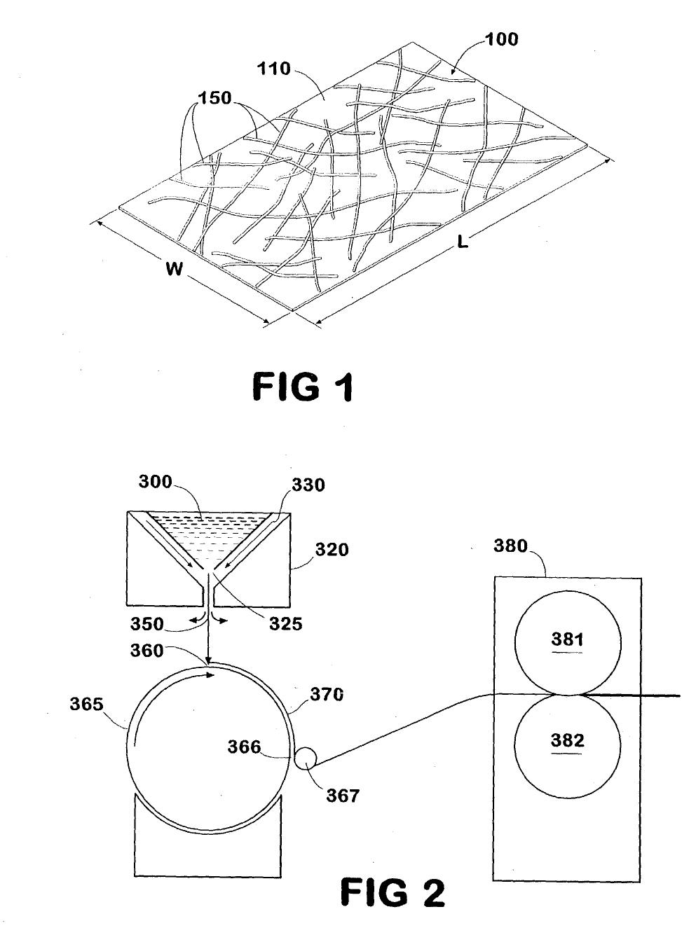

An example of an adhesive nonwoven web of the present invention is shown in FIG. 1. The adhesive nonwoven web 110 of FIG. 1 comprises fibers 150 distributed throughout the adhesive nonwoven web 110. The adhesive nonwoven web 110 has an upper surface 110 and a lower surface 120 (not shown) opposite from upper surface 110. As shown in FIG. 1, adhesive nonwoven web 110 has a width, w, and a length, l.

Desirably, the adhesive nonwoven webs of the present invention possess a degree of adhesive properties as measured by Peel Strength testing. This test is conducted using JENTEX Corporation internal test method JTM0011 derived from ASTM D5034-90, the details of which are described below. The method determines the average force required to separate two substrates of similar or dissimilar material, bonded together using an adhesive nonwoven web, in a direction perpendicular to the plane of the bonded composite.

The adhesive nonwoven webs of the present invention may be prepared using any material, which provides a desired amount of adhesive properties. In an exemplary embodiment of the present invention, the adhesive nonwoven webs comprise a plurality of fibers, wherein the fibers comprise a copolymer of (a) ethylene and at least one of (b) acrylic acid and methacrylic acid. In one embodiment of the present invention, the adhesive nonwoven web comprises fibers consisting essentially of (a) ethylene and at least one of (b) acrylic acid and methacrylic acid. In a further embodiment of the present invention, the adhesive nonwoven web comprises fibers consisting of (a) ethylene and at least one of (b) acrylic acid and methacrylic acid.

Suitable copolymers of (a) ethylene and at least one of (b) acrylic acid and methacrylic acid for use in the present invention include, but are not limited to, copolymers comprising from about 50 to about 99 weight percent of (a) ethylene and from about 50 to about 1 weight percent of at least one of (b) acrylic acid and methacrylic acid. Desirably, the copolymer comprises about 75 to about 90 weight percent of (a) ethylene and about 25 to about 10 weight percent of at least one of (b) acrylic acid and methacrylic acid. More desirably, the copolymer comprises about 75 to about 85 weight percent of (a) ethylene and about 25 to about 15 weight percent of at least one of (b) acrylic acid and methacrylic acid. In some embodiments, the copolymer comprises about 79.5 weight percent of (a) ethylene and about 20.5 weight percent of at least one of (b) acrylic acid and methacrylic acid. In other embodiments, the copolymer comprises less than 79.5 weight percent of (a) ethylene and greater than 20.5 weight percent of at least one of (b) acrylic acid and methacrylic acid.

In a further exemplary embodiment of the present invention, the adhesive nonwoven webs comprise a plurality of fibers, wherein the fibers comprise a copolymer of (a) ethylene and (b) vinyl acetate. In one embodiment of the present invention, the adhesive nonwoven web comprises fibers consisting essentially of (a) ethylene and (b) vinyl acetate. In a further embodiment of the present invention, the adhesive nonwoven web comprises fibers consisting of (a) ethylene and (b) vinyl acetate.

Suitable copolymers of (a) ethylene and (b) vinyl acetate for use in the present invention include, but are not limited to, copolymers comprising from about 50 to about 99 weight percent of (a) ethylene and from about 50 to about 1 weight percent of (b) vinyl acetate. Desirably, the copolymer comprises about 50 to about 90 weight percent of (a) ethylene and about 50 to about 10 weight percent of (b) vinyl acetate. More desirably, the copolymer comprises about 60 to about 85 weight percent of (a) ethylene and about 40 to about 15 weight percent of (b) vinyl acetate. Even more desirably, the copolymer comprises about 72 to about 82 weight percent of (a) ethylene and about 28 to about 18 weight percent of (b) vinyl acetate. In some embodiments, the copolymer comprises about 82 weight percent of (a) ethylene and about 18 weight percent of (b) vinyl acetate. In other embodiments, the copolymer comprises less than 75 weight percent of (a) ethylene and greater than 25 weight percent of (b) vinyl acetate.

In yet a further exemplary embodiment of the present invention, the adhesive nonwoven webs comprise a plurality of fibers, wherein the fibers comprise a copolymer of (a) ethylene and (b) octene. In one embodiment of the present invention, the adhesive nonwoven web comprises fibers formed from a copolymer consisting essentially of (a) ethylene and (b) octene. In a further embodiment of the present invention, the adhesive nonwoven web comprises fibers formed from a copolymer consisting of (a) ethylene and (b) octene.

Suitable copolymers of (a) ethylene and (b) octene for use in the present invention include, but are not limited to, copolymers comprising from about 50 to about 99 weight percent of (a) ethylene and from about 50 to about 1 weight percent of (b) octene. Desirably, the copolymer comprises about 50 to about 90 weight percent of (a) ethylene and about 50 to about 10 weight percent of (b) octene. More desirably, the copolymer comprises about 60 to about 85 weight percent of (a) ethylene and about 40 to about 15 weight percent of (b) octene. Even more desirably, the copolymer comprises about 72 to about 82 weight percent of (a) ethylene and about 28 to about 18 weight percent of (b) octene. In some embodiments, the copolymer comprises about 82 weight percent of (a) ethylene and about 18 weight percent of (b) octene. In other embodiments, the copolymer comprises less than 75 weight percent of (a) ethylene and greater than 25 weight percent of (b) octene.

Desirably, the copolymers used to form the fibers of the adhesive nonwoven webs of the present invention have a melt flow index of from about 6 g/10 min to about 2500 g/10 min as measured according to ASTM D-1238-Condition-190° C./2.16 Kg-load. More desirably, the copolymers have a melt flow index of from about 350 g/10 min to about 2500 g/10 min as measured according to ASTM D-1238-Condition-190° C./2.16 Kg-load. Even more desirably, the copolymers have a melt flow index of from about 500 g/10 min to about 1000 g/10 min as measured according to ASTM D-1238-Condition-190° C./2.16 Kg-load.

In addition, it is desirable to use copolymers to form the fibers of the adhesive nonwoven webs of the present invention wherein the copolymers have a melting point of from about 60° C. to about 125° C. as measured according to ASTM D-3418 (DSC) (Differential Scanning Calorimetry). More desirably, the copolymers have a melting point of from about 60° C. to about 110° C., even more desirably, 68° C. to about 104° C. as measured according to ASTM D-3418 (DSC).

The fibers of the adhesive nonwoven web may be continuous or discontinuous. The fibers may be formed by a number of processes including, but not limited to, meltblowing and spunbonding processes. Desirably, the fibers have an average fiber diameter of less than about 100 microns. More desirably, the fibers have an average fiber diameter of from about 0.5 micron to about 80 microns. Even more desirably, the fibers have an average fiber diameter of from about 1 micron to about 60 microns.

In one embodiment of the present invention, the adhesive nonwoven webs comprise fibers formed from one or more copolymers selected from the NUCREL® family of copolymers, available from DuPont de Neumours (Wilmington, Del.); and the PRIMACOR™ family of copolymers, available from The Dow Chemical Company (Midland, Mich.). In another embodiment, the adhesive nonwoven webs comprise fibers formed from one or more copolymers selected from the LUCALEN™ family of copolymers, available from BASF (Mount Olive, N.J.). Desirably, the adhesive nonwoven webs comprise fibers formed from one or more copolymers selected from NUCREL® 699; NUCREL® 960; NUCREL® 2806; PRIMACOR™ 3150; PRIMACOR™ 3440; PRIMACOR™ 3460; PRIMACOR™ 4311; and LUCALEN™ products. More desirably, the adhesive nonwoven webs comprise fibers formed from one or more copolymers selected from NUCREL® 599; NUCREL® 2940; PRIMACOR™ 5980I; PRIMACOR™ 5986; and PRIMACOR™ 5990I; as well as, LUCALEN™ products.

In a further embodiment of the present invention, the adhesive nonwoven webs comprise fibers formed from one or more copolymers selected from the ELVAX® family of copolymers, available from DuPont de Neumours (Wilmington, Del.). Desirably, the adhesive nonwoven webs comprise fibers formed from one or more copolymers selected from ELVAX® 210; ELVAX® 210W; ELVAX® 310; and ELVAX® 410 products. More desirably, the adhesive nonwoven webs comprise fibers formed from ELVAX® 410 products.

In yet a further embodiment of the present invention, the adhesive nonwoven webs comprise fibers formed from one or more copolymers selected from the AFFINITY™ family of copolymers, available from The Dow Chemical Company (Midland, Mich.). The AFFINITY™ family of copolymers are produced using Dow's INSITE™ metallocene process. Desirably, the adhesive nonwoven webs comprise fibers formed from one or more copolymers selected from the XUS 59800.02 product or the XUS 59800.05 product. A description of the XUS 59800.02 and XUS 59800.05 products is given in Table 1 below.

TABLE 1
XUS 59800.02 and XUS 59800.05 Product Descriptions

| Property | XUS 59800.05 | XUS 59800.02 |
|---|---|---|
| Density | 0.874 | 0.87 |
| Viscosity | 17,000 | 8200 |
| Estimated MI | 500 | 1000 |
| Melting Point (° C.) | 70 | 68 |
| Glass Transition | −57 | −57.5 |
| Temperature - Tg (° C.) | | |
| Tensile Strength (psi) | 255 | 225 |
| Ultimate Elongation | 185 | 106 |

It should be noted that the adhesive nonwoven webs of the present invention may comprise fibers formed from one or more copolymers selected from the NUCREL® family of copolymers; the PRIMACOR™ family of copolymers; the LUCALEN™ family of copolymers; the ELVAX® family of copolymers; and the AFFINITY™ family of copolymers. Any of the above-mentioned copolymers may be used alone or in combination with one another to form fibers and adhesive nonwoven webs of the present invention.

In one embodiment of the present invention, adhesive nonwoven webs comprise monocomponent fibers comprising any one of the above-mentioned copolymers. In this embodiment, the monocomponent fibers may contain additives as described below, but comprise a single fiber-forming material selected from the above-described copolymers. Further, in this embodiment, the monocomponent fibers of the adhesive webs of the present invention comprise at least 75 weight percent of any one of the above-described copolymers with up to 25 weight percent of one or more additives. Desirably, the monocomponent fibers of the adhesive webs of the present invention comprise at least 80 weight percent, more desirably at least 85 weight percent, at least 90 weight percent, at least 95 weight percent, and as much as 100 weight percent of any one of the above-described copolymers, wherein all weights are based on a total weight of the fiber.

The adhesive nonwoven webs of the present invention may also comprise multicomponent fibers formed from (1) one or more of the above-described copolymers and (2) one or more additional fiber-forming materials. As used herein, the term “multicomponent fiber” is used to refer to a fiber formed from two or more fiber-forming materials. As discussed above, the multicomponent fiber for forming the adhesive webs of the present invention may be formed from two or more of the above-described copolymers. In one desired embodiment, the adhesive nonwoven webs are formed from fibers, wherein the fibers comprise (1) one or more of the above-described copolymers and (2) one or more additional fiber-forming materials, wherein at least one of the above-described copolymers occupies at least a portion of an outer surface of the fibers. Suitable additional fiber-forming materials include, but are not limited to, polyethylene; polypropylene; polybutene; polyethylene terephthalate; polybutylene terephthalate; polyamide (Nylon-6 and Nylon-6,6); polyurethane; polylactic acid; and polyvinyl alcohol. Suitable resulting fiber configurations include, but not limited to, a sheath-core configuration, a side-by-side configuration, and an “island-in-the-sea” configuration. In one desired embodiment, the adhesive nonwoven web comprises sheath-core fibers, wherein one of the above-described copolymer forms the sheath of the fibers.

For adhesive webs of the present invention formed from multicomponent fibers, desirably the multicomponent fiber comprises (1) at least about 10 weight percent of one or more of the above-described copolymers and (2) up to about 90 weight percent of one or more additional fiber-forming materials based on the total weight of the fiber. More desirably, the multicomponent fiber comprises (1) from about 25 to about 99 weight percent of one or more of the above-described copolymers and (2) from about 75 to about 1 weight percent of one or more additional fiber-forming materials based on the total weight of the fiber. Even more desirably, the multicomponent fiber comprises (1) from about 50 to about 99 weight percent of one or more of the above-described copolymers and (2) from about 50 to about 1 weight percent of one or more additional fiber-forming materials based on the total weight of the fiber. Even more desirably, the multicomponent fiber comprises (1) from about 75 to about 99 weight percent of one or more of the above-described copolymers and (2) from about 25 to about 1 weight percent of one or more additional fiber-forming materials based on the total weight of the fiber.

In one exemplary embodiment of the present invention, the adhesive nonwoven webs comprise multicomponent fibers, wherein the multicomponent fibers comprise (i) a copolymer of (a) ethylene and (b) octene, and (ii) an additional fiber-forming material comprising polypropylene. In this embodiment, the adhesive nonwoven web desirably comprises multicomponent fibers, wherein the multicomponent fibers comprise from about 5 wt % to about 30 wt % of the ethylene/octene copolymer and from about 95 wt % to about 70 wt % of polypropylene, based on a total weight of the fiber-forming components. More desirably, the adhesive nonwoven web comprises multicomponent fibers, wherein the multicomponent fibers comprise from about 10 wt % to about 30 wt % of the ethylene/octene copolymer and from about 90 wt % to about 70 wt % of polypropylene, based on a total weight of the fiber-forming components. Even more desirably, the adhesive nonwoven web comprises multicomponent fibers, wherein the multicomponent fibers comprise from about 20 wt % to about 30 wt % of the ethylene/octene copolymer and from about 80 wt % to about 70 wt % of polypropylene, based on a total weight of the fiber-forming components.

It has been discovered that the polypropylene component used to form the above-described multicomponent fibers also contributes to the adhesive properties of the polymer blend and fibers formed therefrom. Although a variety of polypropylenes may be used in the present invention, desirably the polypropylene has a melt flow rate (MFR) ranging from about 350 to about 1500. Such polypropylenes have been found to produce superior adhesive properties when blended with at least one of the above-described ethylene/octene copolymers. Suitable polypropylenes having a melt flow rate (MFR) ranging from about 350 to about 1500 are commercially available from Sunoco Chemicals (Pittsburgh, Pa.) and Atofina Petrochemicals Inc. (Houston, Tex.).

In one desired embodiment, adhesive nonwoven webs of the present invention comprise multicomponent fibers formed from a blend of (i) XUS 59800.02, and (ii) a polypropylene having a MFR of about 1500 (such as those available from Sunoco Chemicals (Pittsburgh, Pa.)). In a more desired embodiment, adhesive nonwoven webs of the present invention comprise multicomponent fibers formed from a blend of (i) XUS 59800.02, and (ii) a polypropylene having a MFR of about 350 (such as those available from Atofina Petrochemicals Inc. (Houston, Tex.)). In an even more desired embodiment, adhesive nonwoven webs of the present invention comprise multicomponent fibers formed from a blend of (i) XUS 59800.05, and (ii) a polypropylene having a MFR of about 350 (such as those available from Atofina Petrochemicals Inc. (Houston, Tex.)).

The adhesive nonwoven webs of the present invention may comprise (1) any of the above-described monocomponent or multicomponent fibers formed from the above-described copolymers and (2) at least one other type of fiber. In this embodiment, the adhesive nonwoven web comprises at least about 5 weight percent (wt %) of fibers formed from the above-described copolymers, and up to about 95 wt % of one or more additional types of fibers. Desirably, the adhesive nonwoven web of the present invention comprises about 70 to about 95 wt % of fibers formed from the above-described copolymers, and from about 30 to about 5 wt % of one or more additional types of fibers. Suitable additional types of fibers include, but are not limited to, fibers formed from polyethylene, polypropylene, polybutene, polyethylene terephthalate, polybutylene terephthalate, polyamide (Nylon-6 and Nylon-6,6), polyurethane, polylactic acid, and polyvinyl alcohol, as well as, fibers sold under the trade designation EXCEVAL™, available from Kuraray Company, Ltd. (Osaka, Japan).

The adhesive nonwoven webs of the present invention may have a basis weight, which varies depending upon the particular end use of the web. Desirably, the adhesive nonwoven web of the present invention has a basis weight of less than about 500 grams per square meter (gsm). More desirably, the adhesive nonwoven web of the present invention has a basis weight of from about 2.5 gsm to about 500 gsm. Even more desirably, the adhesive nonwoven web of the present invention has a basis weight of from about 8 gsm to about 100 gsm.

As with the basis weight, the adhesive nonwoven webs of the present invention may have a thickness, which varies depending upon the particular end use of the web. Desirably, the adhesive nonwoven web of the present invention has a thickness of less than about 1750 microns (μm). More desirably, the adhesive nonwoven web of the present invention has a thickness of from about 100 μm to about 500 μm. Even more desirably, the adhesive nonwoven web of the present invention has a thickness of from about 120 μm to about 400 μm.

In most embodiments, the fibers within the adhesive nonwoven web are uniformly distributed within the web. However, there may be some embodiments wherein it is desirable to have a non-uniform distribution of fibers within an adhesive nonwoven web.

In addition to the fiber-forming materials mentioned above, various additives may be added to the fiber melt and extruded to incorporate the additive into the fiber. Typically, the amount of additives is less than about 25 weight percent, desirably, up to about 2.5 percent, based on the total weight of the fiber. Suitable additives include, but are not limited to, fillers, stabilizers, plasticizers, tackifiers, flow control agents, cure rate retarders, adhesion promoters (for example, silanes and titanates), adjuvants, impact modifiers, expandable microspheres, thermally conductive particles, electrically conductive particles, and the like, such as silica, glass, clay, talc, pigments, colorants, glass beads or bubbles, antioxidants, optical brighteners; antimicrobial agents; surfactants; fire retardants; and fluoropolymers. One or more of the above-described additives may be used to reduce the weight and/or cost of the resulting fiber and web, adjust viscosity, or modify the thermal properties of the fiber or confer a range of physical properties derived from the physical property activity of the additive including: electrical; optical; density-related, liquid barrier or adhesive tack related.

II. Adhesive Films

The present invention is also directed to adhesive materials in the form of an adhesive film. The adhesive films may comprise one or more film-forming materials. Desirably, the adhesive films comprise one or more of the above-described copolymers. More desirably, the adhesive films comprise one or more of the above-described copolymers of (a) ethylene and at least one of (b) acrylic acid and methacrylic acid, such as the above-described NUCREL® family of copolymers and the above-described PRIMACOR™ family of copolymers. Even more desirably, the adhesive films comprise one or more copolymers selected from NUCREL® 599, NUCREL® 2940, PRIMACOR™ 3150, PRIMACOR™ 5980I, PRIMACOR™ 5986, PRIMACOR™ 5990I, or a combination thereof.

The adhesive films of the present invention may be formed by film-forming techniques known in the art including, but not limited to, extrusion, casting, blowing, and any other film-forming process. The adhesive film may also be incorporated into more complex cast film structures containing two or more components manufactured as discrete layers through “tandem” extrusion manufacturing technology in which one layer of the multi-layer film construction possesses adhesive properties and the other layer (or layers) provide other physical properties of benefit to the composite film structure.

The adhesive films of the present invention desirably have a basis weight of up to about 500 gsm. Using any of the above-described film-forming techniques and a stretching process (described below), adhesive films having a relatively low basis weight may be produced. For example, adhesive films may be produced, wherein the adhesive films have a basis weight of less than 50 gsm. In some desired embodiments, the adhesive films have a basis weight of from about 5 gsm to about 25 gsm. In other desired embodiments, the adhesive films have a basis weight of from about 10 gsm to about 20 gsm.

The adhesive films of the present invention desirably comprise at least about 10 wt % of one or more of the above-described copolymers based on a total weight of film-forming materials. More desirably, the adhesive films comprise at least about 20 wt % of one or more of the above-described copolymers based on a total weight of film-forming materials. Even more desirably, the adhesive films comprise at least about 50 wt % of one or more of the above-described copolymers based on a total weight of film-forming materials. Even more desirably, the adhesive films comprise at least about 75 wt % of one or more of the above-described copolymers based on a total weight of film-forming materials. Even more desirably, the adhesive films comprise at least about 95 wt % of one or more of the above-described copolymers based on a total weight of film-forming materials.

Additional film-forming polymers may be blended with one or more of the above-described copolymers to form adhesive films of the present invention. Suitable additional fiber-forming materials include, but are not limited to, the polymers described above as suitable additional fiber-forming materials.

III. Multilayer Webs Having Adhesive Properties

The present invention is further directed to multilayer webs containing two or more layers, wherein at least one layer comprises an adhesive nonwoven web, an adhesive layer of fibers, or an adhesive film having adhesive properties. Desirably, at least one outermost layer of the multilayer web comprises an adhesive nonwoven web, an adhesive layer of fibers, or an adhesive film having adhesive properties.

A. Multilayer Webs Containing One or More Adhesive Nonwoven Webs

In one embodiment of the present invention, the multilayer web comprises two or more layers, wherein at least one layer comprises at least one adhesive nonwoven web as described above. In this embodiment, the multilayer web is formed by bonding one or more adhesive nonwoven webs to one or more layers via heat and/or pressure. Suitable layers (i.e., the additional layers) for use in combination with the one or more adhesive nonwoven webs include, but are not limited to, a non-fibrous adhesive layer; a non-adhesive film; a glass fiber-filled film composite; a foil; a paper; a foam; a woven fabric; a nonwoven fabric; a needlepunched nonwoven; a spunbonded nonwoven; a knitted fabric; a mesh; an elastic fabric (i.e., any of the above-described woven, knitted or nonwoven fabrics having elastic properties); or a combination thereof. The additional layers may be temporary or permanently attached to the one or more adhesive nonwoven webs depending upon the degree of adhesion between the substrates, and the amount of heat and/or pressure applied to the substrates during bonding. Desirably, at least one outermost layer of the multilayer web comprises an adhesive nonwoven web.

B. Multilayer Webs Containing a Layer of Fibers Having Adhesive Properties

In a further embodiment of the present invention, the multilayer web comprises two or more layers, wherein at least one layer comprises a layer of fibers having adhesive properties. It should be noted that the layer of fibers having adhesive properties is not a nonwoven fabric. Unlike the single-layered, adhesive nonwoven webs of the present invention described above, the layer of fibers having adhesive properties does not possess enough structural integrity to form a nonwoven fabric. In other words, the layer of fibers cannot be formed without a supporting substrate.

The layer of fibers may comprise any of the above-mentioned copolymers (i.e., copolymers of (a) ethylene and at least one of (b) acrylic acid, methacrylic acid, vinyl acetate, and octene) alone or in combination with other fibers. In one desired embodiment of the present invention, the layer of fibers comprises fibers formed from a copolymer of (a) ethylene and (b) methyl acrylate (i.e., “EMA copolymers”). In a further desired embodiment of the present invention, the layer of fibers comprises fibers consisting essentially of (a) ethylene and (b) methyl acrylate. In yet a further desired embodiment of the present invention, the layer of fibers comprises fibers consisting of (a) ethylene and (b) methyl acrylate.

Suitable copolymers of (a) ethylene and (b) methyl acrylate for use in the present invention include, but are not limited to, copolymers comprising from about 50 to about 99 weight percent of (a) ethylene and from about 50 to about 1 weight percent of (b) methyl acrylate. Desirably, the copolymer comprises about 75 to about 90 weight percent of (a) ethylene and about 25 to about 10 weight percent of (b) methyl acrylate. More desirably, the copolymer comprises about 80 to about 90 weight percent of (a) ethylene and about 20 to about 10 weight percent of (b) methyl acrylate. In one embodiment, the copolymer comprises about 80.5 weight percent of (a) ethylene and about 19.5 weight percent of (b) methyl acrylate.

Desirably, the copolymers used to form the layer of fibers have a melt flow index of from about 6 g/10 min to about 2500 g/10 min as measured according to ASTM D-1238-Condition-190° C./2.16 Kg-load. More desirably, the copolymers have a melt flow index of from about 350 g/10 min to about 2500 g/10 min as measured according to ASTM D-1238-Condition-190° C./2.16 Kg-load.

In addition, it is desirable for the copolymers used to form the layer of fibers to have a melting point of from about 60° C. to about 125° C. as measured according to ASTM D-3418 (DSC) (Differential Scanning Calorimetry). More desirably, the copolymers have a melting point of from about 70° C. to about 110° C., even more desirably, 72° C. to about 104° C. as measured according to ASTM D-3418 (DSC).

The fibers in the layer of fibers may be continuous or discontinuous. The fibers may be formed by a number of processes including, but not limited to, meltblowing and spunbonding processes. Desirably, the fibers are formed by a meltblowing process and have an average fiber diameter of less than about 100 microns. More desirably, the fibers have an average fiber diameter of from about 0.5 micron to about 80 microns. Even more desirably, the fibers have an average fiber diameter of from about 1 micron to about 60 microns.

In one embodiment of the present invention, the layer of fibers comprises fibers formed from one or more EMA copolymers sold under the trade designation, OPTEMA®, available from ExxonMobil Chemicals (Houston, Tex.). Desirably, the layer of fibers comprises fibers formed from an EMA copolymer available under the trade designation OPTEMA® TC-140.

In this embodiment, the multilayer web is formed by depositing a layer of fibers onto a substrate. The fibers may autogenously bond to the substrate as the fibers are deposited onto the substrate. Suitable substrates include, but are not limited to, an adhesive nonwoven web as described above; a non-fibrous adhesive layer; a non-adhesive film; a glass fiber-filled film composite; a foil; a paper; a foam; a woven fabric; a nonwoven fabric; a needlepunched nonwoven; a spunbonded nonwoven; a knitted fabric; a mesh; an elastic fabric (i.e., any of the above-described woven, knitted or nonwoven fabrics having elastic properties); or a combination thereof.

In one desired embodiment, the multilayer web of the present invention comprises a substrate having a first layer of adhesive fibers overblown onto a surface of the substrate, wherein the substrate is a spunbonded nonwoven fabric or a chemically-bonded nonwoven fabric and the first layer of adhesive fibers comprises EMA fibers. Desirably, the spunbonded nonwoven fabric comprises polyester fibers. More desirably, the spunbonded polyester nonwoven fabric comprises a melt-extruded isotropic nonwoven comprising fibers formed from greater than 50 wt % polyethylene terephthalate (PET) and less than 50 wt % of a co-polyester having a lower melting point than the PET. The fibers are bonded to one another by the application of heat and pressure using a thermal bonding calender with an engraved pattern, otherwise known as “point-bonded”, or without a pattern, otherwise known as flat calendered.

As used herein, the term “chemically-bonded nonwoven fabric” refers to a web of staple-length fibers (i.e., fibers having a length of less than about 10 cm.), such as polyester fibers, cotton fibers, rayon fibers, or a combination thereof, which have been chemically bonded to one another using a thermosettable composition. The thermosettable composition may be sprayed onto the web of staple-length fibers. Alternatively, the web of staple-length fibers may pass through a dip containing the thermosettable composition. The thermosettable composition may be heatset to form a hardened thermoset binder, which integrally bonds the staple-length fibers to one another.

In this embodiment, a layer of fibers having adhesive properties is deposited onto a surface of a substrate. The layer of fibers is typically deposited in an amount of less than about 500 grams per square meter (gsm). Desirably, the layer of fibers having adhesive properties is deposited in an amount of from about 2.5 gsm to about 500 gsm. More desirably, the layer of fibers having adhesive properties is deposited in an amount of from about 8 gsm to about 100 gsm. Even more desirably, the layer of fibers having adhesive properties is deposited in an amount of from 10 gsm to about 50 gsm.

As with the areal weight, the layer of fibers having adhesive properties may be deposited to obtain a layer thickness, which varies depending upon the particular end use of the web. Desirably, the layer of fibers has a thickness of less than about 1750 microns (μm). More desirably, the layer of fibers has a thickness of from about 80 μm to about 500 μm. Even more desirably, the layer of fibers has a thickness of from about 90 μm to about 300 μm.

The layer of fibers may be permanently or temporarily bonded to a supporting substrate. In one embodiment of the present invention, the layer of fibers is temporarily bonded to a release liner. The layer of fibers may be subsequently permanently bonded to a second substrate, and the release liner removed to form a multi-layer article having an outer surface in the form of an adhesive layer of fibers.

C. Multilayer Webs Containing An Adhesive Film Layer

In a further embodiment of the present invention, the multilayer web comprises two or more layers, wherein at least one layer comprises an adhesive film layer. The adhesive film layer may be formed as described above, and subsequently bonded to at least one additional layer. The adhesive film layer may be bonded to the at least one additional layer using any known bonding technique including, but not limited to, point-bonding, calendering, etc.

IV. Methods of Making Adhesive Nonwoven Webs and Multilayer Webs

The adhesive nonwoven webs of the present invention may be prepared in a number of ways. One exemplary method of making the adhesive nonwoven webs of the present invention is depicted in FIG. 2.

As shown in FIG. 2, molten polymer 300 is introduced into a die assembly 320. Die assembly 320 comprises a plurality of spinnerets (not shown) from which molten polymer 300 is extruded. Molten polymer 300 exits die assembly 320 at location 325 and enters into a curtain of process air 330. The curtain of process air 330 attenuates extruded polymer fibers 350 as the fibers 350 travel a distance d from an exit of the plurality of spinnerets (not shown) to a collection surface at location 360 on an outer surface of drum 365. Drum 365 rotates at a desired speed to form a nonwoven material 370, which moves along an outer surface of drum 365. Nonwoven fabric 370 moves along drum 365 to point 366, wherein a nip roll 367 contacts the nonwoven fabric 370 and guides the fabric off of drum 365 onto an outer surface of nip roll 367. Nonwoven fabric 370 may process onto other processes along the process line, such as a calender assembly 380.

Calender assembly 380 comprises a first roll 381 and a second roll 382 which nip the nonwoven fabric 370 to further bond the fibers of the fabric to one another. First roll 381 and second roll 382 may have a smooth surface to form bonding sites throughout nonwoven fabric 370. Alternatively, at least one of first roll 381 and second roll 382 has raised portions along the roll surface, which results in a point-bonding pattern across nonwoven fabric 370. Each point of the point-bonding pattern may have any shape and size desired. The total bonded area of the nonwoven fabric 370 may vary from about 5 to about 95 percent of the total surface area of the fabric.

The method of making an adhesive nonwoven web of the present invention may be used to form an adhesive nonwoven web containing fibers formed from any of the above-mentioned fiber-forming materials. In one desired embodiment, the method comprises: melt extruding a copolymer through a plurality of spinnerets to form a plurality of fibers; and collecting the fibers on a collection surface to form a web of fibers; wherein the copolymer comprises (a) ethylene and at least one of (b) acrylic acid, methacrylic acid, vinyl acetate, and octene. In a further embodiment, the copolymer consists essentially of (a) ethylene and at least one of (b) acrylic acid, methacrylic acid, vinyl acetate, and octene. In yet a further embodiment, the copolymer consists of (a) ethylene and at least one of (b) acrylic acid, methacrylic acid, vinyl acetate, and octene.

In one method of making an adhesive nonwoven web of the present invention, the method comprises melt extruding at least one copolymer, such as one or more selected from NUCREL® 599; NUCREL® 2940; PRIMACOR™ 5980I; PRIMACOR™ 5986; and PRIMACOR™ 5990I; as well as, LUCALEN™ products, ELVAX® products or AFFINITY™ products, through a plurality of spinnerets to form a plurality of fibers; and collecting the fibers on a collection surface to form a web of fibers.

In one variation of the above-described method, a plurality of additional fibers (other than the fibers formed from copolymer material) may be deposited onto the adhesive nonwoven web to form a composite web. The plurality of additional fibers may be melt-extruded from an adjacent die assembly or may be staple-length fibers deposited from a fiber storage bin.

The method of making an adhesive nonwoven web of the present invention may be used to produce multicomponent fibers comprising the above-described copolymer material and at least one additional component, wherein the copolymer occupies at least a portion of an outer surface of the fibers. The method may be used to produce multicomponent fibers having any of the fiber configurations described above. Desirably, the method produces an adhesive nonwoven web comprising sheath-core fibers, wherein one of the above-described copolymer forms the sheath of the fibers.

As the plurality of fibers exits the die assembly and are exposed to attenuating air, the plurality of fibers may be further contacted with at least one of quenched air, a second plurality of fibers, and at least one additional layer (or substrate). The plurality of fibers may be collected to form a single-layered adhesive nonwoven web as described above. Alternatively, the plurality of fibers may be deposited onto a substrate to form a multilayer web as described above. Suitable additional layers, which may be brought into contact with the plurality of fibers, include, but are not limited to, a film release liner; a woven or nonwoven release liner, such as one comprising fibers having an inherent low surface energy or fibers, which have undergone a reaction chemistry that renders a low surface energy; a non-fibrous adhesive layer; a non-adhesive film; a glass fiber-filled film composite; a foil; a paper; a foam; a woven fabric; a nonwoven fabric; a needlepunched nonwoven; a spunbonded nonwoven; a knitted fabric; or a combination thereof. The additional layer may be temporary or permanently attached to the adhesive nonwoven web depending upon the degree of adhesion between the two substrates, and the amount of heat and/or pressure applied to the substrates.

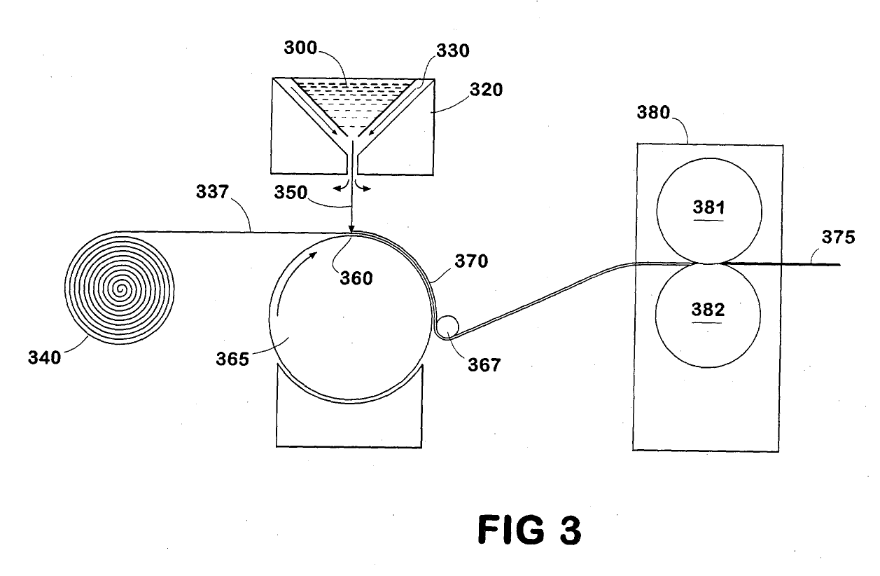

One method of forming a multilayer article is shown in FIG. 3. As the fibers 350 travel a distance d from an exit of the plurality of spinnerets (not shown) to the collection surface at location 360 on an outer surface of drum 365, a second substrate 337 is brought into contact with the plurality of fibers 350. Second substrate 337 can be any of the above-described additional layers stored in roll-form 340. In calender assembly 380, first roll 381 and a second roll 382 bond the fibers of the adhesive nonwoven fabric 370 to one another and also bond an outer surface of the adhesive nonwoven web 370 to an outer surface of substrate 337. The degree of bonding within the adhesive nonwoven web and to the second substrate 337 may vary as described above.

It should be noted that one or more additional substrates may be brought into contact with the adhesive nonwoven web at a location downstream from drum 365. For example, an additional layer may be brought into contact with adhesive nonwoven web at a location between nip roll 367 and calender assembly 380.

In one desired embodiment of the present invention, a multilayer composite web is formed by introducing a second substrate 337 in the form of a chemically-bonded nonwoven into the pathway of the fibers 350 at location 360 on the collection surface of drum 365 as shown in FIG. 3. The chemically-bonded nonwoven may comprise a nonwoven fabric coated with a thermoset, cross-linked material, such as a polyester, cotton, or polyester/cotton fabric coated with an epoxy resin coating. Suitable examples of chemically-bonded nonwoven fabrics include, but are not limited to, those produced by Freduenberg Nonwoven's and the Lantor Group.

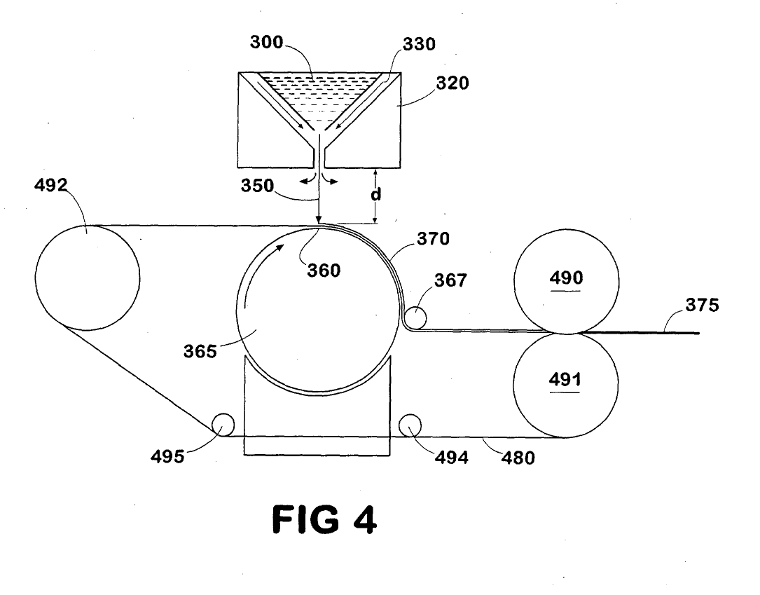

Another variation of the above-described method of making an adhesive nonwoven web of the present invention is shown in FIG. 4. In this embodiment, fibers 350 travel a distance d from an exit of the plurality of spinnerets (not shown) to the collection surface at location 360 on an outer surface of drum 365. At point 360, fibers 350 are deposited onto an endless belt 480. Endless belt 480 forms an endless loop around drum 365, nip roll 367, rolls 491, 492, 494, and 495. In this embodiment, endless belt 480 provides support for adhesive nonwoven web 370 until web 370 passes through a bonding station (i.e., calender assembly). This method is particularly useful when adhesive nonwoven fabric 370 does not have enough structural integrity prior to a bonding station.

Typically, the method of the present invention involves melt extruding a thermoformable material at a melt extrusion temperature of from about 130° C. to about 350° C.

The die assembly comprises a plurality of spinnerets through which molten thermoformable material is extruded. Desirably, the die assembly comprises a plurality of spinnerets, wherein the number of spinneret holes through the die is at least 700 spinneret holes per linear meter. Typically, the plurality of spinnerets has an average hole diameter of from about 0.25 to about 0.75 mm.

Desirably, the method of making an adhesive nonwoven web comprises melt extruding a thermoformable material, such as the above-described copolymers, at a rate of at least 25 kilograms per hour per linear meter of extrusion width (k/hr/lm).

Desirably, the method of making an adhesive nonwoven web comprises using a stream of air to attenuate the plurality of extruded fibers at a point below an exit of the plurality of spinnerets within the die assembly. The exit of the plurality of spinnerets may be positioned a distance, d, above the collection surface. In one embodiment of the present invention, the distance, d, may be adjusted by moving the plurality of spinnerets up or down relative to the collection surface. This may be beneficial for control of fiber size, substrate pore size, fiber fusion, and substrate basis weight uniformity. Desirably, distance, d, may vary from about 100 mm to about 1500 mm.

The stream of air used to attenuate the plurality of extruded fibers desirably has an air speed of from about 5 meters per second (ms⁻¹) to about 300 ms⁻¹. Further, the stream of air desirably has an air temperature of from about 175° C. to about 400° C.

In one embodiment of the present invention, the method uses a die assembly comprising a plurality of spinnerets wherein the plurality of spinnerets are arranged along a die having a length, l, and a width, w, with an upper surface (i.e., die entrance), a lower surface (i.e., die exit), two side surfaces, and two end surfaces. Typically, the die assembly has a length, l, of from about 0.05 meters (m) to about 3 m extending in a first direction perpendicular to the web (i.e., the cross direction of the web); and a width, w, of from about 1 mm to about 100 mm extending in a second direction parallel to the web (i.e., the machine direction of the web). A plurality of spinneret holes extends in a direction from the upper surface to the lower surface. A stream of attenuating air may contact the plurality of fibers at a point below an exit of the plurality of spinnerets, wherein the stream of air flows through slots positioned along the two side surfaces (see FIGS. 2-4).

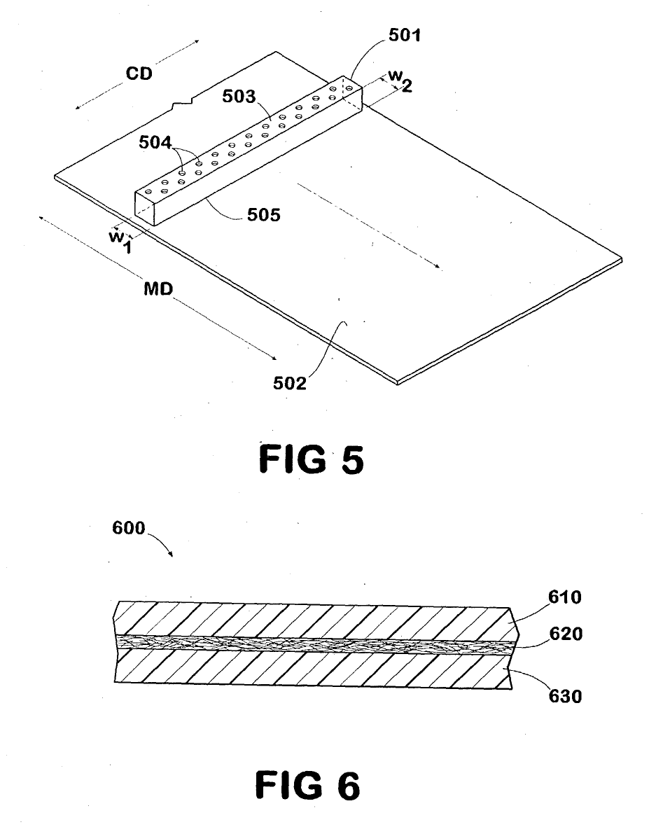

An exemplary die assembly and collection surface for use in the process of making an adhesive nonwoven web of the present invention is shown in FIG. 5. Die 501 is positioned over collection surface 502. Die 501 has an upper surface 503 and a lower surface 505. A plurality of spinneret holes 504 are shown in upper surface 503.

It should be noted that the collection surface may be in the form of a flat surface (as shown in FIG. 5) as oppose to a rotating drum (as shown in FIGS. 2-4). The collection surface may comprise a drum supporting a carrier material; an endless belt, a horizontal table; a horizontal table supporting a carrier material; or a tenter frame supporting a carrier material.

Desirably, the collection surface is a drum having a diameter of from about 0.3 m to about 2.0 m, and a width of from about 0.05 m to about 3 m. The drum may have an outer surface comprising a smooth metal surface or a wire screen mesh. Desirably, the drum has an outer surface comprising a wire screen mesh.

The speed of the drum may vary depending on the throughput of the process line. Desirably, an outer surface of the drum has a linear speed of from about 0.1 m/min to about 150 m/min.

The method of the present invention may include any of the above-described features to produce adhesive nonwoven fabrics containing any of the above-described fibers. In addition, the method of the present invention may include one or more of the following process steps:

(1) rotating the drum to advance the web along an outer surface of the drum;

(2) nipping the adhesive nonwoven web between a nip roll and the drum, wherein the web separates from the drum at a nip point and follows a web path along an outer surface of the nip roll;

(3) calendaring the web;

(4) coating the web with a surface treatment;

(5) attaching the web to a cardboard or plastic tube;

(6) taking-up the web in-the form of a roll; and

(7) slitting the web to form two or more slit rolls.

V. Methods of Making Stretched Adhesive Materials

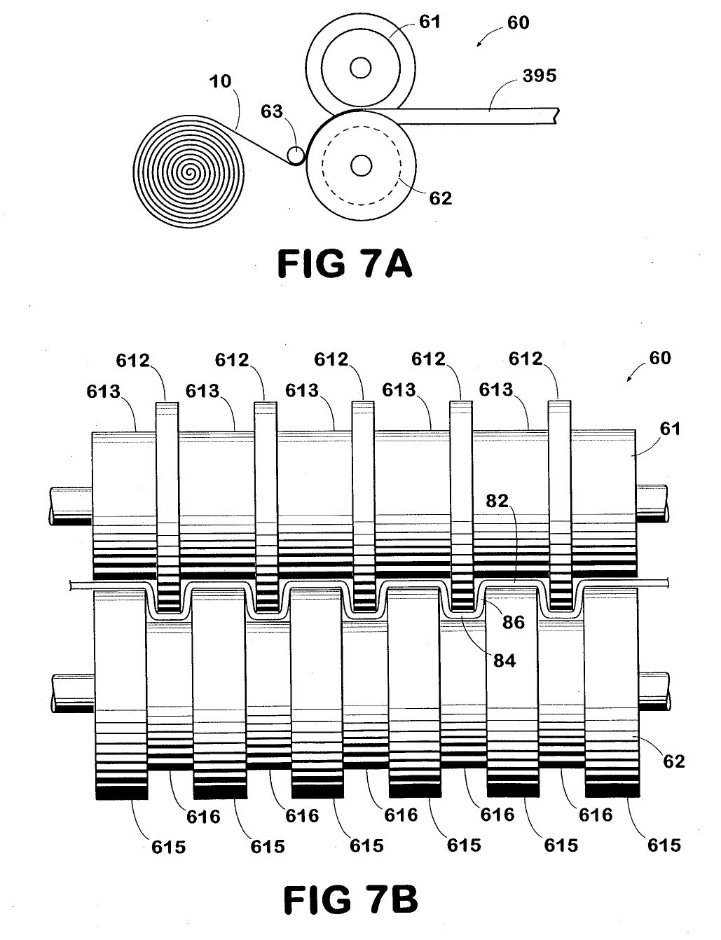

The above-described (i) adhesive webs, (ii) adhesive layer of fibers, (iii) adhesive films, (iv) multilayer webs, or (iii) any layer within the multilayer webs of the present invention may be further processed through a stretching apparatus, such as the exemplary stretching apparatus shown in FIG. 7A. As shown in FIG. 7A, exemplary multilayer web 10 proceeds through stretching apparatus 60 and exits as stretched multilayer web 395. Stretching apparatus 60 comprises two interengaged drums, upper drum 61 and lower drum 62, and a nip roller 63. Each drum consists of alternating discs having different disc diameters. A cross-sectional view of upper drum 61 and lower drum 62 is given in FIG. 7B.

As shown in FIG. 7B, upper drum 61 consists of alternating discs 612 and 613 having a larger disc diameter, d₆₁₂, and a smaller diameter, d₆₁₃, respectively. Lower drum 62 also consists of alternating discs 615 and 616 having a larger disc diameter, d₆₁₅, and a smaller diameter, d₆₁₆, respectively. As multilayer web 10 approaches stretching apparatus 60, tension is exerted on multilayer web 10 by nip roller 63 to keep multilayer web 10 positioned next to lower drum 62. As multilayer web 10 proceeds through stretching apparatus 60, a stretching force is exerted on multilayer web 10 so as to stretch multilayer web 10 in specific areas referred to herein as “microstretched portions.” The microstretched portions extend in the machine direction of the stretched multilayer web 395, and are located substantially between adjacent peaks and valleys as described below.

As shown in FIG. 7B, discs 612 on upper drum 61 exert a stretching force on multilayer web 10, forcing portions of multilayer web 10 into the gaps between discs 615 on lower drum 62. Peaks 82 and valleys 84 are formed in multilayer web 10. The areas between peaks 82 and valleys 84 are microstretched portions 86. It is believed that a substantial amount of the total stretching of multilayer web 10 occurs in microstretched portions 86. The distance between peaks 82 and valleys 84 (and the length of microstretched portions 86 as measured in the cross direction of multilayer web 10) may vary depending on the width and diameters of discs 612, 613, 615 and 616. Further, it is believed that peaks 82 and valleys 84 have a higher concentration of bonds between the multilayer web layers (e.g., upper layer 11 and lower layer 12) compared to a bond concentration in the microstretched portions 86.

Typically, discs 612, 613, 615 and 616 have a width ranging from about 0.5 mm (20 mil.) to about 3.0 mm (120 mil.), desirably, from about 1.0 mm (40 mil.) to about 1.5 mm (60 mil.). In one exemplary embodiment of the present invention, discs 612, 613, 615 and 616 have the following widths: disc 612—1.27 mm (50 mil.); disc 613—2.54 mm (100 mil.); disc 615—1.27 mm (50 mil.); and disc 616—2.54 mm (100 mil.).

Typically, discs 612, 613, 615 and 616 have a diameter ranging from about 5.1 cm (2 inches (in.)) to about 61.0 cm (24 in.), desirably, from about 7.6 cm (3 in.) to about 30.5 cm (12 in.). In one exemplary embodiment of the present invention, discs 612, 613, 615 and 616 have the following diameters: disc 612—17.8 cm (7 in.); disc 613—15.2 cm (6 in.); disc 615—17.8 cm (7 in.); and disc 616—15.2 cm (6 in.).

One suitable stretching apparatus for stretching the above-described (i) adhesive webs, (ii) adhesive layer of fibers, (iii) adhesive films, (iv) multilayer webs, or (iii) any layer within the multilayer webs (collectively referred to herein as the “pre-stretched material”) of the present invention is disclosed in U.S. Pat. No. 4,368,565 assigned to Biax-Fiberfilm Corporation (Neenah, Wis.), the entire content of which is hereby incorporated by reference.

The pre-stretched material of the present invention may be laterally stretched using the above-describe stretching apparatus to increase the width of the pre-stretched material up to about 40% (i.e., the final width is 1.4 times the original width). Desirably, the pre-stretched material is laterally stretched to a final width, which is from about 2% to about 40% greater than the original width of the pre-stretched material, more desirably, from about 10% to about 30% greater than the original width of the pre-stretched material.

It should be noted that any single layer of the above-described adhesive webs and multilayer webs of the present invention may be laterally stretched using the above-describe stretching apparatus prior to being joined to one or more other layers. For example, an adhesive web layer or adhesive film layer may be stretched to increase the width of the adhesive web layer or adhesive film layer up to about 40% (i.e., the final width is 1.4 times the original width) prior to joining the adhesive web layer or adhesive film layer to a second fabric layer. Typically, prior to being stretched, the adhesive web layer is calendered as described above, although calendering is an optional step. After stretching the adhesive web layer, the stretched adhesive web layer may be joined to the second fabric layer to form a multilayer web material. The resulting multilayer web material may be further processed as described below.

In one desired embodiment of the present invention, the multilayer web material comprises (i) a calendered, stretched adhesive web layer comprising a meltblown adhesive nonwoven fabric, and (ii) a second meltblown fabric layer bonded to the stretched adhesive web layer. In this embodiment, the adhesive web layer is desirably laterally stretched to a final width, which is from about 2% to about 40% greater than the original width of the adhesive web layer, more desirably, from about 10% to about 30% greater than the original width of the adhesive web layer. The second meltblown fabric layer may be either (i) point-bonded to the stretched adhesive web layer at a desired bond cover area of from about 30% to about 40% based on a total surface area of the bonded composite material, or (ii) overblown onto the stretched adhesive web layer (using the meltblowing process described above and depicted in FIG. 6) to produce a composite material. Desirably, the second meltblown fabric layer is overblown onto the stretched adhesive web layer to produce a composite material.

VI. Stretched Adhesive Materials and Stretched Composite Materials Containing the Same

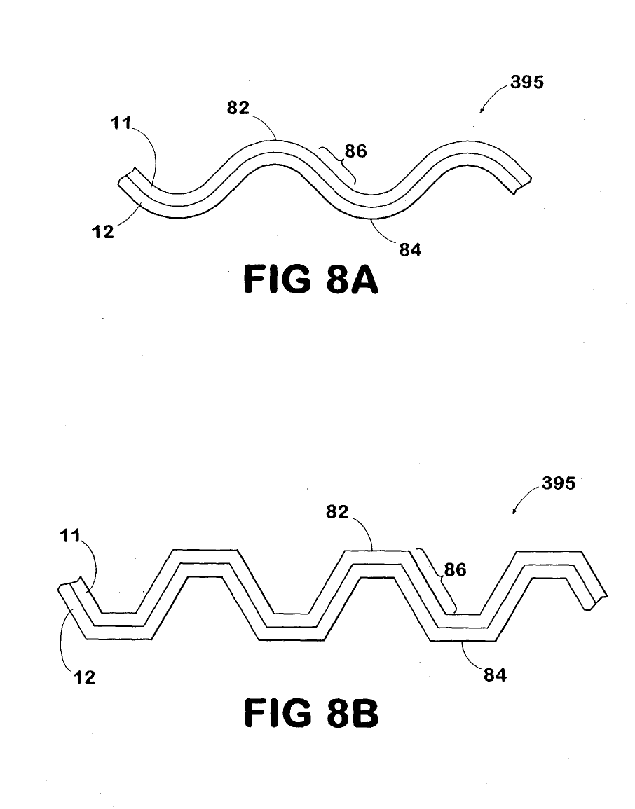

The stretched adhesive nonwoven webs, stretched layer of adhesive fibers, stretched adhesive film and/or stretched composite materials of the present invention (collectively referred to herein as the “stretched materials”) may have a cross-sectional configuration along a cross direction of the web, layer, film or composite, which varies depending on the stretching apparatus used. As used herein, the term “stretched composite materials” refers to composite materials of the present invention wherein (i) the entire composite material is stretched or (ii) at least one layer of the composite material (e.g., the adhesive web layer) is stretched using the method as described above. In one exemplary embodiment of the present invention, the stretched material has a wave-like cross-sectional configuration along a cross direction of the stretched material, wherein the wave-like cross-sectional configuration contains a plurality of alternating peaks and valleys. Exemplary wave-like cross-sectional configurations are shown in FIGS. 8A and 8B.

As shown in FIGS. 8A and 8B, exemplary stretched composite material 395 may have a sine-wave shape (FIG. 8A) or a truncated cone-wave shape (FIG. 8B). It should be noted that stretched composite material 395 may have other cross-sectional configurations depending on the shape and dimensions of the alternating discs used to stretch the composite material. In FIGS. 8A and 8B, stretched composite material 395 has peaks 82, valleys 84, and microstretched portions 86 positioned between peaks 82 and valleys 84. In a desired embodiment of the present invention, the microstretched portions 86 extend in the machine direction of stretched composite material 395, and are located substantially between adjacent peaks 82 and valleys 84.

As shown in FIG. 8B, stretched composite material 395 may have a cross-sectional configuration, wherein each peak 82 is separated from adjacent peaks as viewed along the cross direction of stretched composite material 395 and located substantially within a first plane. Likewise, each valley 84 may be separated from adjacent valleys as viewed along the cross direction of stretched composite material 395 and located substantially within a second plane parallel with and below the first plane. The microstretched portions 86 are located substantially between the first plane and the second plane. In one embodiment of the present invention, stretched composite material 395 have a cross-sectional configuration, wherein the average distance between adjacent peaks ranges from about 1.0 mm to about 10.0 mm, and the average distance between adjacent valleys ranges from about 1.0 mm to about 10.0 mm. As-used herein, the term “distance between adjacent peaks” refers to the distance between the apex of one peak and the apex of an adjacent peak. Desirably, the average distance between adjacent peaks ranges from about 2.0 mm to about 6.0 mm, and the average distance between adjacent valleys also ranges from about 2.0 mm to about 6.0 mm.

In a further embodiment of the present invention, stretched composite material 395 has a cross-sectional configuration, wherein the microstretched portions 86 have an average width as measured along the cross direction of stretched composite material 395 between the first plane and the second plane ranging from about 0.05 mm to about 8.0 mm, more desirably, from about 1.0 mm to about 3.0 mm.

It should be understood that when the stretched composite material of the present invention comprises a stretched layer (e.g., a stretched adhesive web layer) and an unstretched layer (e.g., a second nonwoven layer), the composite material may still have any of the above-described cross-sectional configurations having peaks and valleys as described above. However, the above-described microstretched portions will only be present within the stretched layer of the composite material.

As discussed above, the stretched materials of the present invention may have a final width of at least 2% greater than the bonded pre-stretched materials. Further, the stretched materials of the present invention (or a stretched layer thereof) may have a final thickness of at least 20% greater than the pre-stretched material (or pre-stretched layer). Desirably, the stretched material (or a stretched layer thereof) has a final thickness of from about 30% to about 60% greater than the pre-stretched material (or pre-stretched layer), more desirably, from about 35% to about 50% greater than the pre-stretched material (or pre-stretched layer).

Desirably, the stretched material (or a stretched layer of the composite material) has the following properties:

(1) an overall thickness at least 40% greater than a pre-stretched thickness of the adhesive web or composite material (or layer of the composite material); and

(2) an overall width of at least 10% greater than a pre-stretched material width of the adhesive web or composite material.

In one desired embodiment of the present invention, the stretched adhesive material comprises a stretched adhesive film formed from one or more of the above-described copolymers, desirably, copolymers of (a) ethylene and at least one of (b) acrylic acid and methacrylic acid. The stretched adhesive film desirably has an areal weight of less than about 25 grams per square meter (gsm), more desirably, from about 5 gsm to about 25 gsm, even more desirably, from about 10 gsm to about 20 gsm. In this embodiment, the film may contain not only adhesive co-polymer systems, but also conventional polymers that do not display adhesive properties, but whose presence as a blended ingredient serves to improve physical properties of the film such as tenacity, etc. These polymers may be chosen on the basis of melting point characteristics that are close to that of the adhesive co-polymer system or are significantly different from the adhesive co-polymer system, depending upon the application.

VII. Methods of Using Adhesive Materials

The adhesive nonwoven webs, layer of adhesive fibers, and adhesive films of the present invention may be used in a variety of applications. The adhesive nonwoven webs, layer of adhesive fibers, and adhesive films may be used to bond a substrate to itself, or to bond two similar or different substrates to one another. The adhesive nonwoven webs, layer of adhesive fibers, and adhesive films of the present invention may be used to bond together a variety of substrates. Suitable substrates, which may be bonded together using the adhesive nonwoven web, layer of adhesive fibers, or adhesive film of the present invention, include, but are not limited to, plastics, metals, ceramics, glass, cellulosic materials, natural fiber fabrics, synthetic fiber fabrics, elastomeric substrates such as rubber, composite materials such as fiber-reinforced plastics (FRP), wood-containing materials, and combinations thereof. An exemplary bonded article is shown in FIG. 5, wherein the bonded article 500 comprises first substrate 510 bonded to second substrate 530 via adhesive nonwoven web 520 positioned between first substrate 510 and second substrate 530.

Typically, the adhesive nonwoven web, layer of adhesive fibers, or adhesive film of the present invention is brought into contact with a first substrate. A second substrate is then brought into contact with the exposed surface of the adhesive nonwoven web, layer of adhesive fibers, or adhesive film. Alternatively, a second portion of the first substrate is folded to form a: sandwich-like structure with the adhesive nonwoven web, layer of adhesive fibers, or adhesive film positioned between portions of the first substrate. A desired amount of heat and pressure may be applied to insure maximum surface contact between the substrates and the adhesive nonwoven web, layer of adhesive fibers, or adhesive film.

The second substrate (or a second portion of the first substrate) may typically be bonded to an exposed surface of the adhesive nonwoven web, layer of adhesive fibers, or adhesive film using heat, or both pressure and heat, (for example, with a heated press, heated nip rollers, a heated laminator or a steam press). Bonding conditions depend on a number of factors including, but not limited to, the composition of the adhesive nonwoven web, layer of adhesive fibers, or adhesive film; the melting point of adhesive nonwoven web, layer of adhesive fibers, or adhesive film; the basis weight of the adhesive nonwoven web, layer of adhesive fibers, or adhesive film; the nature of substrates that are being bonded to the adhesive nonwoven web, layer of adhesive fibers, or adhesive film; the pressure applied to the composite; the length of time for applying pressure and/or heat; and the temperature of the heat. When the temperature is slightly above the melting temperature of the adhesive nonwoven web, layer of adhesive fibers, or adhesive film, the time for applying pressure and/or heat may be lengthened or shortened by a change in the application temperature, the application pressure or any of the other aforementioned dependent variables.

VIII. Specific Bonded Articles

The present invention is directed to a variety of multilayer articles formed by one or more similar (or different) substrates and an adhesive nonwoven web, layer of adhesive fibers, or adhesive film. A number of particularly desirable bonded articles include, but are not limited to, fabric bonded to fabric including high performance materials with properties including ultra-high tenacity, high cut-resistance and associated properties; fabric bonded to any one or more of the following: metal including aluminum, nonwoven materials, film, vinyl-based materials, foam based upon a range of chemistries, paper and board, hard plastics, wood and wood composites, glass, ABS and fiberglass, or other composites created from combinations of these or different materials. Any of the above materials may be bonded to one another using the adhesive nonwoven webs of the present invention.

In some multilayer articles, the inherent flame resistance of the adhesive nonwoven webs of the present invention becomes evident. It has been discovered that the adhesive nonwoven webs of the present invention inherently possess a degree of flame resistance when exposed to a flame. The adhesive nonwoven webs possess flame resistance properties similar to nonwoven webs formed from polyolefins, and possess exceptional flame resistance properties when compared to similar nonwoven webs formed from copolyamides and copolyesters. One desired multilayer article, which demonstrates the flame resistance properties of the above-described adhesive nonwoven webs, comprises aramid fabrics separated by an adhesive nonwoven web comprising NUCREL® 2940 copolymer. The aramid fabrics may be woven or nonwoven fabrics, but are desirably woven fabrics formed from KEVLAR™ fibers, although NOMEX™ and BASOFIL™ fibers are also suitable.

In a further embodiment of the present invention, a multilayer article comprises a needle-punched fabric wherein a thermally-insulating fleece material is needle-punched to an adhesive nonwoven web. This multilayer article has great utility in that the multilayer article may be sold in roll form to a consumer, and subsequently used by the consumer to attach to a substrate of the consumer's choice. For example, the multilayer article may be positioned next to a 100% cotton woven fabric and bonded by an ironing process to the 100% cotton woven fabric. Any conventional iron may be used to bond the fabric layers to one another. Typically, the iron produces steam, which penetrates the thermally-insulating fleece layer and melts the adhesive web to form a bonded article. This method of bonding may be used with any iron or other heating device, which produces steam or some other form of heat at a temperature greater than the melting point of the adhesive nonwoven web. The method may be used to produce a variety of multilayer articles from the substrates described above.

The adhesive nonwoven webs of the present invention have particular utility in the apparel industry due to the adhesive characteristics of the adhesive nonwoven webs, as well as, the adhesive characteristics following a dry cleaning process. Unlike some adhesive webs, the adhesive nonwoven webs of the present invention retain their adhesive properties after exposure to the chemicals and processing conditions associated with a dry cleaning process.

The present invention is described above and further illustrated below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

The following examples were conducted using the materials shown in Table 2 below.

TABLE 2
Adhesive Materials

| Trade Designation/ | | |
|---|---|---|
| Material | | |
| (Copolymer) | Source | Description |
| NUCREL ® | DuPont Company | Ethylene (E)/methacrylic |
| 599 | (Wilmington, DE) | acid (MAA) copolymer |
| | | 10 wt % MAA |
| | | MFI = 500 g/10 min |
| NUCREL ® | DuPont Company | Ethylene (E)/methacrylic |
| 2940 | (Wilmington, DE) | acid (MAA) copolymer |
| | | 19 wt % MAA |
| | | MFI = 395 g/10 min |
| PRIMACOR ™ | Dow Chemical | Ethylene (E)/Acrylic acid |
| 5990I | Company | (AA) copolymer |
| | (Midland, MI) | 20 wt % AA |
| | | MFI = 1300 g/min |
| PRIMACOR ™ | Dow Chemical | Ethylene (E)/Acrylic acid |
| 5986 | Company | (AA) copolymer |
| | (Midland, MI) | 20.5 wt % AA |
| | | MFI = 300 g/min |
| ELVAX ® | DuPont Company | Ethylene (E)/Vinyl |
| 210 | (Wilmington, DE) | Acetate (VA) copolymer |
| | | 28 wt % VA |
| | | MFI = 400 g/10 min |
| OPTEMA ® | ExxonMobil | Ethylene (E)/Methyl |
| TC-140 | Chemical | Acrylate (MA) copolymer |
| | (Houston, TX) | 21.5 wt % MA |
| | | MFI = 135 g/10 min |
| AFFINITY ™ | Dow Chemical | Melting Point = 70° C. |
| XUS 59800.05 | Company | Estimated MFI = 500 |
| | (Midland, MI) | g/10 min |
| Type 3960 | Atofina | MFR = 350 |
| Polypropylene | Petrochemicals Inc. | |
| | (Houston, TX) | |

### Example 1

### Preparation of Adhesive Nonwoven Webs

A fiber-producing melt was prepared by melting a fiber composition comprising NUCREL® 2940 at a melt temperature of about 230° C. The polymer melt was extruded a rate of 100 kilograms per hour per linear meter of extrusion width (kg/hr/lm) using an apparatus similar to the apparatus as shown in FIG. 2. The molten polymer was introduced into a die assembly having a height of 0.13 m, a width of 0.15 m, and a length of 1 m, and comprising a plurality of spinnerets having a hole diameter of 0.305 mm, wherein the number of spinneret holes through the die was 1378 spinneret holes per linear meter.

The molten polymer exited the die assembly and entered into a curtain of process air having an air temperature of 260° C. and an air speed of 366 cfm. The curtain of process air attenuated the extruded fibers as the fibers traveled a distance d (d=230 mm) from an exit of the plurality of spinnerets to a collection surface on an outer surface of a rotating drum having an outer diameter of 0.66 m. The drum was rotating with a linear speed of 40 m/min.

The plurality of fibers moved along an outer surface of the rotating drum and was removed from the drum by a nip roll assembly onto an endless belt. The plurality of fibers was then wound-up on a cardboard core.

The resulting adhesive nonwoven fabric had a basis weight of 30 gsm and a thickness of 0.35 mm.

### Example 2

### Preparation of a Multi-Layer Adhesive Nonwoven Web

The adhesive nonwoven web prepared in Example 1 was combined with a second nonwoven layer designed to confer reinforcement or “stiffness” to the composite web. The second web was a spunbonded polyester nonwoven material available from BBA Nonwovens and sold under the trade designation REEMAY™.

The two webs were attached to one another using a method similar to that shown in FIG. 3, wherein the spunbonded polyester nonwoven material was introduced into the stream of extruded filaments at the collection surface. The extruded filaments bonded to the spunbonded polyester nonwoven material without further processing. The composite web moved along an outer surface of the rotating drum and was then removed from the drum by a nip roll assembly. The composite was then wound-up on a cardboard core. The resulting composite web had a basis weight of 65 gsm.

### Example 3

### Preparation of a Multi-Layer Adhesive Nonwoven Web

A composite web was produced as described in Example 2 except the second web was a. carded chemically-bonded nonwoven material available from Freudenberg Nonwovens. The resulting composite web had a basis weight of 65 gsm.

The resulting composite web was used to prepare a furniture skirting material. The fusible composite web was applied and bonded to a fabric substrate, woven available from a wide range of furniture textile manufacturers, using an FM1200F, FM 18000F, or FM 24000F bonded available from Pennsylvania Sewing Research Co. (Dunmore, Pa.).

### Example 4

### Preparation of Bonded Articles Using an Adhesive Nonwoven Web

A bonded article was produced by needlepunching (1) an adhesive nonwoven web formed by a process as described in Example 1 and having a basis weight of 15 gsm to (2) a nonwoven fleece substrate available from Thantex. Specialties Inc. having a basis weight of 220 gsm.

The resulting composite web portion was positioned next to a woven cotton fabric with the nonwoven fleece up. A domestic iron having a surface temperature of>100° C. and a steam temperature of 100° C. was placed on the nonwoven fleece surface and moved over the surface using gentle pressure for a period of 8-10 seconds. The composite web was bonded to the cotton fabric using the surface temperature of the iron, as well as, the heat from the steam penetrating through the nonwoven fleece layer.

The bonding step was repeated using substrates other than a cotton fabric. Other substrates included other woven fabrics, nonwoven fabrics, and films, each of which had a melting point of greater than 100° C.

### Example 5

### Preparation of Adhesive Nonwoven Webs

An adhesive nonwoven web was prepared as described in Example 1 except ELVAX® 210 was used instead of NUCREL® 2940. The ELVAX® 210 was melted at a melt temperature of about 185° C. The polymer melt was extruded a rate of 100 kilograms per hour per linear meter of extrusion width (kg/hr/lm) using an apparatus similar to the apparatus as shown in FIG. 2. The molten polymer was introduced into a die assembly having a height of 0.13 m, a width of 0.15 μm, and a length of 1 m, and comprising a plurality of spinnerets having a hole diameter of 0.305 mm, wherein the number of spinneret holes through the die was 1378 spinneret holes per linear meter.

The molten polymer exited the die assembly and entered into a curtain of process air having an air temperature of 260° C. and an air speed of 366 cfm. The curtain of process air attenuated the extruded fibers as the fibers traveled a distance d (d=230 mm) from an exit of the plurality of spinnerets to a collection surface on an outer surface of a rotating drum having an outer diameter of 0.66 m. The drum was rotating with a linear speed of 40 m/min.

The plurality of fibers moved along an outer surface of the rotating drum and was removed from the drum by a nip roll assembly onto an endless belt. The plurality of fibers was then wound-up on a cardboard core.

The resulting adhesive nonwoven fabric had a basis weight of 25 gsm and a thickness of 0.35 mm.

### Example 6

### Preparation of a Multilayer Web Containing a Layer of Adhesive Fibers

A multilayer web was prepared by depositing EMA fibers onto a polyester spunbonded nonwoven fabric. OPTEMA® TC-140 was melted at a melt temperature of about 210° C. The polymer melt was extruded a rate of 100 kilograms per hour per linear meter of extrusion width (kg/hr/lm) using an apparatus similar to the apparatus as shown in FIG. 2. The molten polymer was introduced into a die assembly having a height of 0.13 m, a width of 0.15 m, and a length of 1 m, and comprising a plurality of spinnerets having a hole diameter of 0.305 mm, wherein the number of spinneret holes through the die was 1378 spinneret holes per linear meter.

The molten polymer exited the die assembly and entered into a curtain of process air having an air temperature of 260° C. and an air speed of 366 cfm. The curtain of process air attenuated the extruded fibers as the fibers traveled a distance d (d=230 mm) from an exit of the plurality of spinnerets to an outer surface of a polyester spunbonded fabric having a basis weight of about 50 gsm. The polyester spunbonded fabric was moving under the die assembly at a linear speed of about 40 m/min.

The resulting multilayer web was wound-up on a cardboard core. The resulting multilayer web had an overall basis weight of 75 gsm and a thickness of 0.5 mm.

### Example 7

### Preparation of a Stretched Composite Material Comprising an Adhesive Meltblown Web Bonded to a Second Meltblown Web

The pre-stretched composite material formed in Example 6 was laterally stretched in a stretching apparatus as shown in FIGS. 7A-7B. The final nonwoven composite material had a final width 20% greater than the width of the bonded pre-stretched composite.

### Example 8

### Preparation of Adhesive Nonwoven Webs

Adhesive nonwoven webs were prepared as described in Example 1 except the following copolymers shown in Table 3 were each used independently instead of NUCREL® 2940.

TABLE 3
Adhesive Materials Used

| Sample | | |
|---|---|---|
| No. | Copolymer | Melt Temperature |
| 1 | NUCREL ® 599 | 230° C. |
| 2 | PRIMACOR ® 5986 | 215° C. |
| 3 | PRIMACOR ® 5990I | 215° C. |
| 4 | AFFINITY ™ XUS 59800.05 | 210° C. |

In Sample 4, the fiber melt composition comprised 25 wt % AFFINITY™ XUS 59800.05 and 75 wt % polypropylene (Atofina Petrochemicals—Type 3960 (MFR 350)) based on a total weight of the fiber-forming materials.

The resulting adhesive nonwoven fabrics had basis weights ranging from 25 gsm to 40 gsm.

### Example 9

### Preparation of Stretched Adhesive Webs

Each of the adhesive nonwoven fabrics produced in Example 8 were laterally stretched in a stretching apparatus as shown in FIGS. 7A-7B. The final stretched adhesive nonwoven fabrics had final widths 30% greater than the width of the pre-stretched adhesive nonwoven fabrics.

### Example 10

### Preparation of Adhesive Films

Adhesive films were prepared by melt extruding a variety of polymers melts through a slot extruder. The following copolymers shown in Table 4 were each used independently to form adhesive films.

TABLE 4
Adhesive Materials Used

| Sample | | |
|---|---|---|
| No. | Copolymer | Melt Temperature |
| 1 | NUCREL ® 599 | 230° C. |
| 2 | PRIMACOR ® 5986 | 215° C. |
| 3 | PRIMACOR ® 5990I | 215° C. |

The resulting adhesive films had basis weights ranging from 25 gsm to 40 gsm.

### Example 11

### Preparation of Stretched Adhesive Films

Each of the adhesive films produced in Example 10 were laterally stretched in a stretching apparatus as shown in FIGS. 7A-7B. The final stretched adhesive films had final widths 30% greater than the width of the pre-stretched adhesive films. The resulting stretched adhesive films had basis weights ranging from 10 gsm to 25 gsm.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. An adhesive nonwoven web comprising a plurality of fibers autogenously bonded to one another, wherein the fibers comprise a copolymer of (a) ethylene and at least one of (b) acrylic acid, methacrylic acid, vinyl acetate, and octene.

2. The adhesive nonwoven web of claim 1, wherein the copolymer consists essentially of (a) ethylene and at least one of (b) acrylic acid, methacrylic acid, vinyl acetate, and octene.

3. The adhesive nonwoven web of claim 1, wherein the copolymer consists of (a) ethylene and at least one of (b) acrylic acid, methacrylic acid, vinyl acetate, and octene.

4. The adhesive nonwoven web of claim 1, wherein the copolymer comprises from about 50 to about 99 weight percent of (a) ethylene and from about 50 to about 1 weight percent of at least one of (b) acrylic acid and methacrylic acid.

5. The adhesive nonwoven web of claim 4, wherein the copolymer comprises about 75 to about 90 weight percent of (a) ethylene and about 25 to about 10 weight percent of at least one of (b) acrylic acid and methacrylic acid.

6. The adhesive nonwoven web of claim 5, wherein the copolymer comprises acrylic acid.

7. The adhesive nonwoven web of claim 4, wherein the copolymer comprises about 79.5 weight percent of ethylene and about 20.5 weight percent at least one of (b) acrylic acid and methacrylic acid.

8. The adhesive nonwoven web of claim 7, wherein the copolymer comprises acrylic acid.

9. The adhesive nonwoven web of claim 1, wherein the copolymer comprises from about 60 to about 85 weight percent of (a) ethylene and from about 40 to about 15 weight percent of (b) vinyl acetate.

10. The adhesive nonwoven web of claim 9, wherein the copolymer comprises about 72 to about 82 weight percent of (a) ethylene and about 28 to about 18 weight percent of (b) vinyl acetate.

11. The adhesive nonwoven web of claim 9, wherein the copolymer comprises about 82 weight percent of ethylene and about 18 weight percent of (b) vinyl acetate.

12. The adhesive nonwoven web of claim 1, wherein the copolymer comprises from about 50 to about 99 weight percent of (a) ethylene and from about 50 to about 1 weight percent of (b) octene.

13. The adhesive nonwoven web of claim 1, wherein the copolymer has a melt flow index of from about 6 g/10 min to about 2500 g/10 min as measured according to ASTM D-1238 Condition-190° C./2.16 Kg-Load.

14. The adhesive nonwoven web of claim 13, wherein the copolymer has a melt flow index of from about 350 g/10 min to about 2500 g/10 min as measured according to ASTM D-1238 Condition-190° C./2.16 Kg-Load.

15. The adhesive nonwoven web of claim 1, wherein the copolymer has a melting point of from about 60° C. to about 125° C. as measured according to ASTM D-3418 (DSC).

16. The adhesive nonwoven web of claim 11, wherein the copolymer has a melting point of from about 68° C. to about 104° C. as measured according to ASTM D-3418 (DSC).

17. The adhesive nonwoven web of claim 1, wherein the fibers have an average fiber diameter of less than about 100 microns.

18. The adhesive nonwoven web of claim 17, wherein the fibers have an average fiber diameter of from about 1 micron to about 60 microns.

19. The adhesive nonwoven web of claim 1, wherein the web further comprises a plurality of additional fibers.

20. The adhesive nonwoven web of claim 1, wherein the fibers further comprise a second fiber component, wherein the copolymer occupies at least a portion of an outer surface of the fibers.

21. The adhesive nonwoven web of claim 20, wherein the fibers are bicomponent fibers having a sheath/core, side-by-side, segmented pie, or islands-in-the-sea configuration.

22. The adhesive nonwoven web of claim 20, wherein the fibers comprise (i) a copolymer of (a) ethylene and (b) octene, and (ii) the second fiber component comprises polypropylene.

23. The adhesive nonwoven web of claim 22, wherein the fibers comprise from about 5 wt % to about 30 wt % of the copolymer and from about 95 wt % to about 70 wt % of polypropylene.

24. The adhesive nonwoven web of claim 1, wherein the web has a basis weight of from about 2.5 gsm to about 500 gsm.

25. The adhesive nonwoven web of claim 1, wherein the fibers are uniformly distributed within the web.

26. A multi-layer article comprising the adhesive nonwoven web of claim 1 and at least one additional layer.

27. The multi-layer article of claim 26, wherein the at least one additional layer comprises a release liner, a woven or nonwoven release liner comprising fiber having an inherent low surface energy or fibers, which have undergone a reaction chemistry that renders a low surface energy; a non-fibrous adhesive layer; a non-adhesive film; a microporous film; a glass fiber-filled film composite; a foil; a paper; a foam; a woven fabric; a nonwoven fabric; a needlepunched nonwoven; a spunbonded nonwoven; a chemically-bonded nonwoven; a knitted fabric; a layer of adhesive fibers; or a combination thereof.

28. A method of making the adhesive nonwoven web of claim 1, said method comprising:
melt extruding a copolymer through a plurality of spinnerets to form a plurality of fibers; and
collecting the fibers on a collection surface to form a web of fibers;
wherein the copolymer comprises (a) ethylene and at least one of (b) acrylic acid, methacrylic acid, vinyl acetate, and octene.

29. The method of claim 28, further comprising bringing into contact with the web at least one additional layer.

30. The method of claim 29, wherein the at least one additional layer comprises a release liner; a woven or nonwoven release liner comprising fibers having an inherent low surface energy or fibers, which have undergone a reaction chemistry that renders a low surface energy; a non-fibrous adhesive layer; a non-adhesive film; a microporous film; a glass fiber-filled film composite; a foil; a paper; a foam; a woven fabric; a nonwoven fabric; a needlepunched nonwoven; a spunbonded nonwoven; a chemically-bonded nonwoven; a knitted fabric; or a combination thereof.

31. The method of claim 28, wherein the collection surface is a drum having a diameter of from about 0.3 m to about 2.0 m, and a width of from about 0.05 m to about 3.0 m.

32. The method of claim 31, wherein the drum has an outer surface comprising a wire screen mesh.

33. The method of claim 28, further comprising at least one step selected from:
calendaring the web;
coating the web with a surface treatment;
attaching the web to a cardboard or plastic tube;
taking-up the web in the form of a roll; and
slitting the web to form two or more tapes.

34. A fiber comprising a copolymer of (a) ethylene and at least one of (b) acrylic acid, methacrylic acid, vinyl acetate, and octene.

35. The adhesive nonwoven web of claim 1, wherein the adhesive nonwoven web contains a plurality of microstretched portions extending along a machine direction of the adhesive nonwoven web resulting from microstretching the adhesive nonwoven web in a cross direction.

36. The adhesive nonwoven web of claim 1, wherein the adhesive nonwoven web has a wave-like cross-sectional configuration along a cross direction of the adhesive nonwoven web, wherein the wave-like cross-sectional configuration contains a plurality of alternating peaks and valleys.

37. The adhesive nonwoven web of claim 36, wherein each peak has a peak width measured along the cross direction of the adhesive nonwoven web and located substantially within a first plane, and each valley has a valley width measured along the cross direction of the adhesive nonwoven web and located substantially within a second plane parallel with and below the first plane; and wherein the microstretched portions are located substantially between the first plane and the second plane.

38. The adhesive nonwoven web of claim 36, wherein an average first distance between adjacent peaks ranges from about 1.0 mm and about 10.0 mm, and an average second distance between adjacent valleys ranges from about 1.0 mm and about 10.0 mm.

39. The adhesive nonwoven web of claim 36, wherein the peak width is substantially the same for each peak within the plurality of peaks, and the peak width ranges from about 0.1 mm to about 3.0 mm, and wherein the valley width is substantially the same for each valley within the plurality of valley, and the valley width ranges from about 0.1 mm to about 3.0 mm.

40. The adhesive nonwoven web of claim 37, wherein the microstretched portions have an average width as measured along the cross direction of the composite material between the first plane and the second plane ranging from about 0.5 mm to about 6.0 mm.
